(19) United States
(12) Patent Application Publication
(10) Pub. No.: US 2016/0261943 A1
(43) Pub. Date: Sep. 8, 2016

(54) HEADPHONE HAVING VIBRATION FUNCTION

(71) Applicants: Jae Ook RYU, Gyeonggi-do (KR); Dong Yen RYU, Gyeonggi-do (KR); SEIL CONTROLS (THAILAND) CO., LTD., Chonburi (TH)

(72) Inventor: Dong Yen RYU, Gyeonggi-do (KR)

(73) Assignees: SEIL CONTROLS (THAILAND) CO., LTD., Chonburi (TH); Jae Ook RYU, Gyeonggi-do (KR); Dong Yen RYU, Gyeonggi-do (KR)

(21) Appl. No.: 15/026,987

(22) PCT Filed: Oct. 13, 2014
(86) PCT No.: PCT/KR2014/009573

§ 371 Date: Apr. 4, 2016

(30) Foreign Application Priority Data
Oct. 24, 2013 (KR) 10-2013-0126957

(51) Int. Cl. H04R 1/10; H04R 3/00

(52) U.S. Cl. CPC H04R 1/1008; H04R 1/1075; H04R 3/00; H04R 2420/07; H04R 2400/03

(57) ABSTRACT

Disclosed is a headphone having a vibration function, including a frequency converting unit frequency-converting a provided sound source signal to be reproduced in a specific vibration frequency band; and an audio signal output unit receiving a frequency-converted output of the frequency converting unit and the provided sound source signal and providing the frequency-converted output to the vibration speaker module, to allow the vibration speaker module 50 to vibrate according to the frequency-converted output to transfer the vibration to the head of the user through the vibration body and providing the provided sound source signal to the first and second speakers to allow the user to hear the sound by the sound source signal provided through both ears.

### TECHNICAL FIELD

The present invention relates to a headphone having a vibration function, and particularly, to a headphone having a vibration function, in which a vibration body is installed in a band provided in the headphone to generate vibration according to a provided sound source signal and transfer the vibration to a head of a user who wears the headphone on the head, and as a result, the user effectively feels the vibration by the sound source signal through the head to realize a sound by a sound source.

### BACKGROUND ART

A headphone having functions of a cellular phone and an MP3 disclosed in Korean Patent Unexamined Publication No. 10-2007-0112342 includes

a connection band in which the cellular phone and the MP3 are installed on both ends, the cellular phone and the MP3 are installed to match ears of a user, and a center is folded or bent;

the cellular phone installed in a speaker installed on one end of the connection band and installed to match a form of the speaker; and

the MP3 installed in the speaker installed on one end of the connection band opposite to the cellular phone and installed to match the form of the speaker.

However, since the headphone having the functions of the cellular phone and the MP3 in the related art just outputs a general sound through the speaker and cannot generate vibration by the sound, and the like, there is a limit in realizing the sound while wearing the headphone on the head by the user.

### TECHNICAL PROBLEM

The present invention is contrived to solve the aforementioned problem and an object of the present invention is to provide a headphone having a vibration function, in which a vibration body is installed in a band provided in the headphone to generate vibration according to a provided sound source signal and transfer the vibration to a head of a user who wears the headphone on the head, and as a result, the user effectively feels the vibration by the sound source signal through the head to realize a sound by a sound source.

### TECHNICAL SOLUTION

In order to achieve the object,
according to one aspect of the present invention,
a headphone, which includes a band 10 used for wearing on a head of a user, first and second speaker housings 20 and 30 installed on both ends of the band 10, respectively and including first and second speakers therein, respectively, and a vibration body 42 installed in the band 10 to face a head of the user when the user wears the band 10 on the head and vibrating according to vibration of a vibration speaker module 50 provided therein, includes:

a frequency converting unit 110 frequency-converting a provided sound source signal to be reproduced in a specific vibration frequency band; and

an audio signal output unit 140 receiving a frequency-converted output of the frequency converting unit 110 and the provided sound source signal and providing the frequency-converted output to the vibration speaker module 50, to allow the vibration speaker module 50 to vibrate according to the frequency-converted output to transfer the vibration to the head of the user through the vibration body 42 and providing the provided sound source signal to the first and second speakers to allow the user to hear the sound by the sound source signal provided through both ears.

The vibration body 42 may transfer the vibration to the head of the user through the pad 44 installed on the bottom thereof and made of a soft material.

The pad 44 may have a turn-over dish shape and the bottom may be seated on the head of the user, and as a result, the vibration of the vibration body 42 may be effectively transferred to the head of the user.

The provided sound source signal may be provided by a wired method or wirelessly through a wireless receiving unit 100.

The wireless receiving unit 100 may use a Bluetooth communication scheme.

The specific vibration frequency band may be 20 to 16,000 Hz.

### ADVANTAGEOUS EFFECTS

According to the present invention, since a vibration body 42 is installed in a band 10 provided in the headphone to generate vibration according to a provided sound source signal and transfer the vibration to a head of a user who wears the headphone on the head, the user effectively feels vibration by a sound source signal with the head thereof to realize a sound by a sound source.

### DESCRIPTION OF DRAWINGS

FIG. 1 is a perspective view illustrating an embodiment of a headphone having a vibration function according to the present invention.

FIG. 2 is a front view of the headphone having the vibration function illustrated in FIG. 1.

FIG. 3 is a diagram illustrating the headphone having the vibration function illustrated in FIG. 1 viewed from the top.

FIG. 4 is a diagram illustrating the headphone having the vibration function illustrated in FIG. 1 viewed from the bottom.

FIG. 5 is a diagram illustrating a vibration speaker module and a vibration transfer pad provided in a vibration body provided in the headphone having the vibration function illustrated in FIG. 1.

FIG. 6 is a block diagram illustrating each function for driving the headphone having the vibration function illustrated in FIG. 1.

FIGS. 7 to 9 are diagrams illustrating a state in which a user wears the headphone having the vibration function illustrated in FIG. 1 by various methods.

### BEST MODE

Hereinafter, an embodiment of the present invention will be described below in detail with reference to the accompanying drawings.

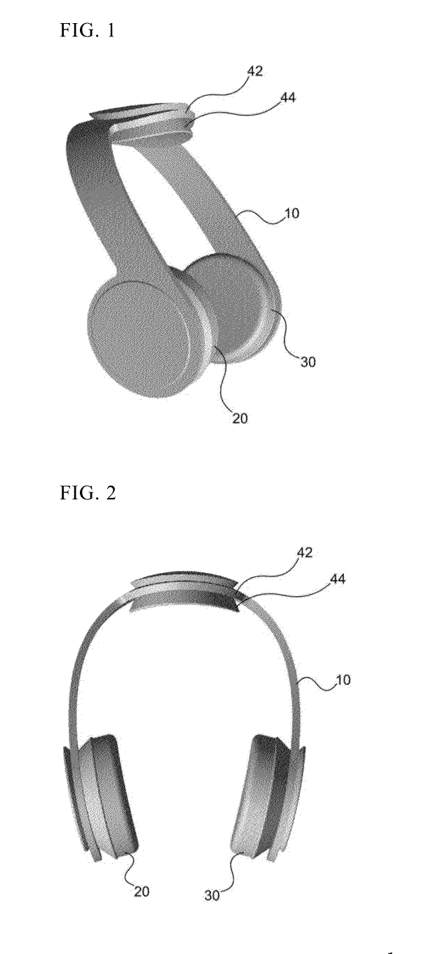

FIG. 1 is a perspective view illustrating an embodiment of a headphone having a vibration function according to the present invention and the headphone is constituted by a band 10, first and second speaker housings 20 and 30, a vibration body 42, and a pad 44.

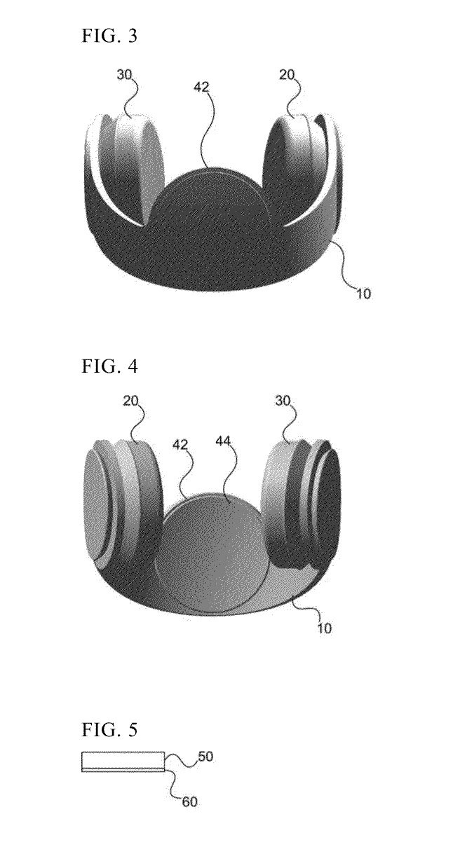

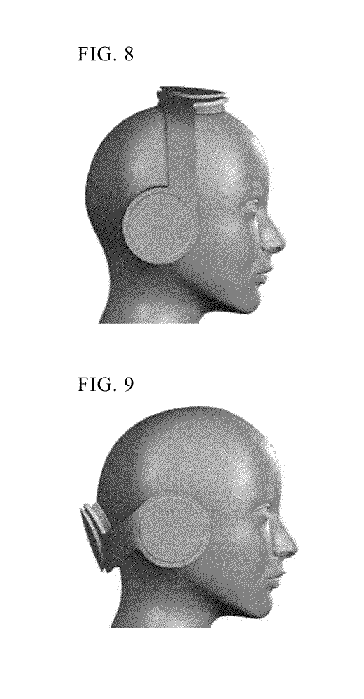

The present invention configured as such will be described below in detail with reference to FIGS. 2 to 9.

FIGS. 2 to 4 are diagrams illustrating the headphone having the vibration function illustrated in FIG. 1 viewed in each direction and FIG. 5 is a diagram illustrating a vibration speaker module 50 and a vibration transfer pad 60 provided in a vibration body 42 provided in the headphone having the vibration function illustrated in FIG. 1.

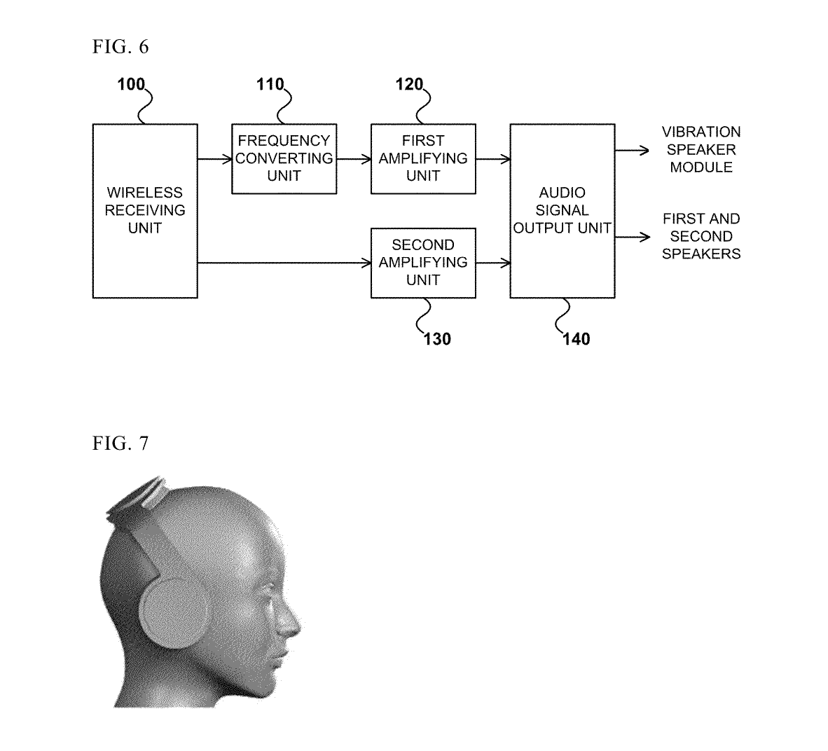

FIG. 6 is a block diagram illustrating each function for driving the headphone having the vibration function illustrated in FIG. 1 and the headphone is constituted by a wireless receiving unit 100, a frequency converting unit 110, first and second amplifying units 120 and 130, and an audio signal output unit 140. Such a configuration of FIG. 6 is mounted on a printed circuit board in which a corresponding circuit is patterned to be installed on an internal vibration speaker module 50 in the vibration body 42 or in another appropriate part of the headphone outside the vibration body 42.

FIGS. 7 to 9 are diagrams illustrating a state in which a user wears the headphone having the vibration function illustrated in FIG. 1 by various methods.

In FIGS. 1 to 6, first, the band 10 is used for wearing on the head of the user and in general, the band 10 has a C-shaped ring form and elasticity to be stably worn on the head of the user.

The first and second speaker housings 20 and 30 are installed on both ends of the band 10, respectively, to include first and second speakers therein, respectively. Therefore, the first and second speakers basically provide a stereo to the user.

When the band 10 is worn on the head of the user, the vibration body 42 is installed in the band 10 to face the head of the user and vibrates according to vibration of the vibration speaker module 50 provided therein. In this case, the vibration body 42 is provided with the vibration speaker module 50 and the vibration transfer pad 60 closely attached onto the bottom of the vibration speaker module 50 therein and the vibration speaker module 50 transfers the vibration to the vibration body 42 through the vibration transfer pad 60. A plurality of vibration bodies 42 may be installed in the band 10 to be spaced part from each other.

The frequency converting unit 110 frequency-converts the provided sound source signal to be reproduced in a specific vibration frequency band. In this case, the specific vibration frequency band may be 20 to 16,000 Hz. The provided sound source signal is provided by a wired method or wirelessly through the wireless receiving unit 100 and the wireless receiving unit 100 may use a Bluetooth communication scheme.

The audio signal output unit 140 receives a frequency-converted output of the frequency converting unit 110 and the provided sound source signal and provides the frequency-converted output to the vibration speaker module 50, and as a result, the vibration speaker module 50 vibrates according to the frequency-converted output to transfer the vibration to the head of the user through the vibration transfer pad 60 and the vibration body 42 and provide the provided sound source signal to the first and second speakers, and as a result, the user hears the sound by the sound source signal provided through both ears. In this case, the audio signal output unit 140 preferably receives the frequency-converted output of the frequency converting unit 110 in an amplified state through the first amplifying unit 120 and receives the provided sound source signal in the amplified state through the second amplifying unit 130.

The vibration body 42 transfers the vibration to the head of the user through the pad 44 installed on the bottom thereof and made of a soft material. In this case, the pad 44 has a turn-over dish shape and the bottom is seated on the head of the user, and as a result, the vibration of the vibration body 42 is effectively transferred to the head of the user.

Meanwhile, as illustrated in FIGS. 7 to 9, the user may wear the headphone having the vibration function according to the present invention by various methods.

The technical spirit of the present invention has been described together with the accompanying drawings hereinabove, but this exemplarily describes a preferred embodiment of the present invention and does not limit the present invention. Further, it is apparent to all those skilled in the art that various modifications and imitations can be made within the range without departing from the scope of the technical spirit of the present invention.

1. A headphone with a vibration function, which includes a band 10 having a C-shaped ring form and elasticity and used for wearing on a head of a user, first and second speaker housings 20 and 30 installed on both ends of the band 10, respectively and including first and second speakers therein, respectively, to provide a stereo to a user, and a vibration body 42 installed in the band 10 to face a head of the user when the user wears the band 10 on the head and vibrating according to vibration of a vibration speaker module 50 provided therein, the headphone comprising:
a frequency converting unit 110 frequency-converting a provided sound source signal to be reproduced in a specific vibration frequency band; and
an audio signal output unit 140 receiving a frequency-converted output of the frequency converting unit 110 and the provided sound source signal and providing the frequency-converted output to the vibration speaker module 50, to allow the vibration speaker module 50 to vibrate according to the frequency-converted output to transfer the vibration to the head of the user through the vibration body 42 and providing the provided sound source signal to the first and second speakers to allow the user to hear the sound by the sound source signal provided through both ears,
wherein the vibration body 42 transfers the vibration to the head of the user through the pad 44 installed on the bottom thereof and made of a soft material, and
the pad 44 has a turn-over dish shape and the bottom is seated on the head of the user, and as a result, the vibration of the vibration body 42 is effectively transferred to the head of the user.

2. The head phone having the vibration function of claim 1, wherein the provided sound source signal is provided by a wired method or wirelessly through a wireless receiving unit 100.

3. The head phone having the vibration function of claim 2, wherein the wireless receiving unit 100 uses a Bluetooth communication scheme.

4. The head phone having the vibration function of claim 1, wherein the specific vibration frequency band is 20 to 16,000 Hz.
